(19) United States
(12) Patent Application Publication
(10) Pub. No.: US 2026/0266108 A1
(43) Pub. Date: Sep. 10, 2026

(54) MOTOR VEHICLE LOCKING DEVICE

(71) Applicant: Kiekert Aktiengesellschaft, Heiligenhaus (DE)

(72) Inventors: Aleš KEJDANA, Prelouc (CZ); Jan SUK, Pardubice (CZ)

(73) Assignee: Kiekert Aktiengesellschaft, Heiligenhaus (DE)

(21) Appl. No.: 18/869,358

(22) PCT Filed: May 23, 2023
(86) PCT No.: PCT/DE2023/100372

§ 371 Date: Apr. 25, 2025

(30) Foreign Application Priority Data
Jun. 3, 2022 (DE) 10 2022 114 138.1

(51) Int. Cl. E05B 83/24; E05B 15/04; E05B 17/00; E05B 77/36; F16F 1/04

(52) U.S. Cl. CPC E05B 83/24; E05B 17/0037; E05B 77/36; F16F 1/042; E05B 2015/041; E05B 2015/0413; F16F 2236/08

(57) ABSTRACT

The invention relates to a motor vehicle locking device, in particular, a motor vehicle lock and preferably a motor vehicle hood lock. The locking device is equipped with a locking mechanism (1, 2) consisting substantially of a rotary latch (1) and a pawl (2). In addition, a leg spring (5) is realized for acting on a locking bolt (3) interacting with the locking mechanism (1, 2). According to the invention, the leg spring (5) has a rectangular cross-section.

The invention relates to a motor vehicle locking device, in particular a motor vehicle lock and preferably a motor vehicle hood lock, having a locking mechanism consisting substantially of a rotary latch and a pawl, and having a leg spring for acting on a locking bolt interacting with the locking mechanism.

Motor vehicle locking devices are typically used on or in motor vehicles to lock doors, flaps, hoods, etc., for example, against a motor vehicle body. The present case primarily concerns motor vehicle locks and in particular motor vehicle hood locks, which are used in conjunction with front hoods or tailgates. On the one hand, there is the problem with front hoods that they tend to make rattling noises due to movements of the motor vehicle or oncoming wind because the locking bolt, held by the rotary latch when the locking mechanism is in a closed state, performs relative movements within an inlet mouth of the rotary latch. On the other hand, it is important that such a front hood can be opened easily.

For this purpose, the procedure is usually and in practice to open the locking mechanism, which is for example in its closed position or main ratchet position, using a handle or an electric motor. With the help of the leg spring, it is then necessary for the front hood to be transferred into a so-called lifting position and at least partially opened. For this purpose, the leg spring works on the locking bolt. In the lifting position, a user can grasp the front hood and swing it open through a gap created thereby between the vehicle body and the front hood. This requires a sufficiently large opening torque on the front hood provided by the leg spring in question.

It should be noted that front hoods are subject to additional weight, for example due to snow or ice thereon, which may prevent the assumption of the lifting position. Accordingly, high opening torques are typically required. In the prior, for example according to DE 10 2006 002 338A1 , these high opening torques are provided by an energy store which moves the front hood into its raised position or the lifting position. The energy store can be several leaf springs. This leads to a bulky structure and a complicated and costly construction.

In the generic prior art according to DE 10 2009 021 613A1 , a damping device is provided which has at least one spring element accommodated in a housing or lock housing. In one design variant, the spring element can be a leg spring. The leg spring works on two jaw elements movable relative to each other that are movably accommodated in the lock housing. The locking bolt is pre-tensioned using the jaw elements. This is intended to prevent any rattling noises from the locking bolt when the locking mechanism is in the closed position.

The prior art has proven itself in principle, but on the one hand relies on a bulky and complicated construction, and on the other hand reaches its limits with regard to the opening torque provided by the leg spring. The invention as a whole seeks to remedy this.

The invention is based on the technical object of further developing such a motor vehicle locking device in such a way that an increased opening torque is provided compared to the prior art, taking into account a compact and cost-effective design.

To solve this technical problem, a generic motor vehicle locking device within the scope of the invention is characterized in that the leg spring has a rectangular cross-section. A variant in which the leg spring has a square cross-section is particularly preferred.

Within the scope of the invention, a leg spring is used first and foremost to directly or indirectly act on the locking bolt. This leg spring has a coil section and two legs connected to or extending from the coil section. In contrast to the prior art according to DE 10 2009 021 613A1 , the leg spring according to the invention no longer has a round cross-section, but rather a rectangular cross-section and in particular a square cross-section. This means that, according to the invention, the spring wire used for the forming process of the leg spring is not equipped with a round cross-section, but rather with a rectangular or square cross-section. This achieves two major advantages over the prior art.

First of all, the opening torque provided by the leg spring with a rectangular or square cross-section and acting on the locking bolt is greater than that of a leg spring of the same design with a round cross-section. In fact, within the scope of the invention, opening torques between 3 Nm and 6 Nm are provided. Preferably, the opening torque is between approximately 4 Nm and 5 Nm. Such opening torques typically correspond to opening forces acting on the locking bolt which are generally above 60 N, in particular more than 80 N and preferably 100 N and more. This provides reliable opening of the front hood, even if there is snow or ice on the front hood, for example.

In addition to increased opening torques or opening forces on the locking bolt compared to the prior art, the claimed leg spring is also equipped with the further advantage that the opening torque between a pre-ratchet position and a main ratchet position of the locking mechanism is not exposed to or subject to major fluctuations. In fact, the opening torque exerted by the leg spring deviates by a maximum of approx. 30% between a pre-ratchet position and a main ratchet position of the locking mechanism. Preferably, only deviations of max. 25% are observed. This means that the opening torque of the leg spring in the pre-ratchet position and the opening torque of the leg spring in the main ratchet position differ by a maximum of 30% and 25% respectively.

All this can be traced back to the rectangular cross-section or square cross-section of the spring wire and therefore of the leg spring according to the invention. In fact, the torsion spring in question is made of steel and, in particular, spring steel. This can be stainless spring steel wire with or without tempering as the starting material for the spring wire for producing the leg spring according to the invention with a rectangular cross-section or square cross-section.

Either way, the spring wire with a rectangular or square cross-section has a significantly higher bending torque compared to the spring wire with a round cross-section. Due to this higher bending torque, the leg spring used according to the invention can, after the forming process, act on the locking bolt with a significantly higher opening torque on its loose leg acting directly or indirectly on the locking bolt compared to the situation where a spring wire with a round cross-section is used as the starting material. These are the main advantages.

As a rule, the design is such that the leg spring with its coil section encloses a bearing pin. This is usually done in such a way that the winding section encloses the bearing pin in question with clearance so that the two legs extending from the winding section can easily enclose different angles between themselves. Most often, obtuse angles are observed at this point. This means that the legs adjoining the winding section enclose the relevant obtuse angle between them.

The obtuse angle between the two legs can assume values between more than 90° and 180°. Preferably, values for the obtuse angle between more than 120° and 180° and particularly preferably between 150° and 180° are observed at this point. Of course, this is only by way of example and by no means mandatory.

Between the above-mentioned values of, for example, 150° and 180°, the corresponding locking mechanism moves from its main ratchet position at approx. 150° to a pre-ratchet position at approximately 180°. This change in angle between the two legs of the leg spring connected to the winding section now corresponds to different opening torques exerted on the locking bolt, which differ from each other by a maximum of 30% according to the preceding explanations. This means that the opening torque exerted by the leg spring according to the invention on the locking bolt, for example in the main ratchet position of the locking mechanism, is generally a max. 30% greater than the opening torque exerted on the locking bolt in the pre-ratchet position. Preferably, only a maximum deviation of 25% between the two mentioned positions is observed.

From a structural point of view, the design is such that the leg spring, with its loose leg, acts on an ejector lever acting on the locking bolt. In contrast, the fixed leg is attached to a housing. The fixed leg can be latchingly connected to the housing. In contrast, the release arm usually rests on the underside of a contact edge of the ejector lever. The contact edge of the ejector lever is in turn attached to the locking bolt.

In addition, it has proven advantageous in this context if the ejector lever in question and the locking pawl are mounted relative to each other on the same axis. The common bearing pin, which is enclosed by the winding section of the leg spring according to the invention, ensures the axially identical mounting.

As a result, a motor vehicle locking device is provided which, with a simple construction, provides an increased opening torque for acting on the locking bolt compared to the prior art. In addition, there is an equalization of the opening torque acting on the locking bolt or the force acting on the locking bolt in the opening direction between the main ratchet position and the pre-ratchet position of the locking mechanism. According to the invention, deviations in the opening torque or opening force of a max. 30% are observed between these two positions.

In contrast, the prior art at this point mainly works with deviations in the opening torque and therefore also in the opening force on the locking bolt between the pre-ratchet position and the main ratchet position, which can amount to 50% or more. As a result, according to the invention, a perfect assumption of the raising or lifting position of the front hood is observed and, at the same time, an improvement in the noise behavior because rattling noises are observed neither in the main ratchet position nor in the pre-ratchet position. These are the main advantages.

In the following, the invention is explained in more detail with the aid of a drawing showing only an exemplary embodiment; in the figures:

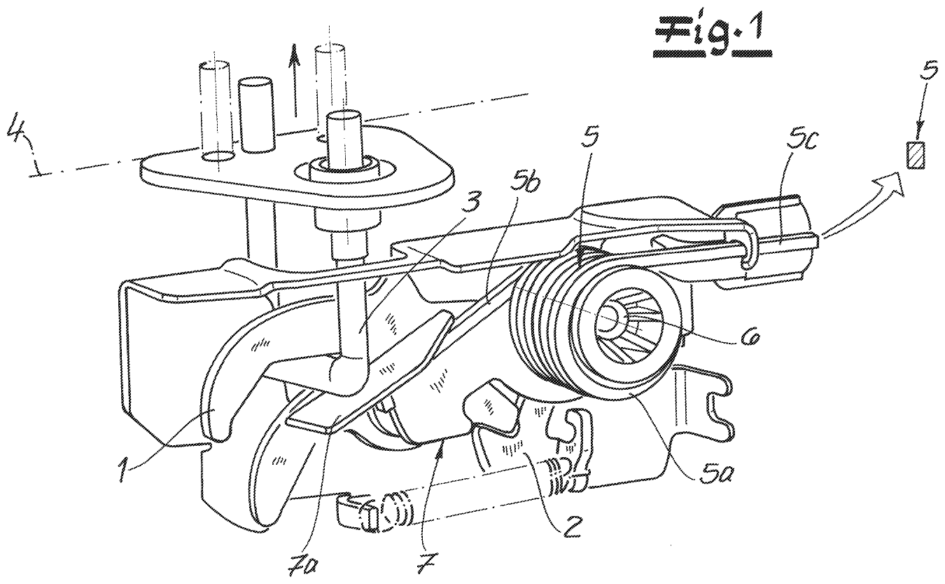

FIG. 1 shows a perspective overview of the motor vehicle locking device according to the invention, and

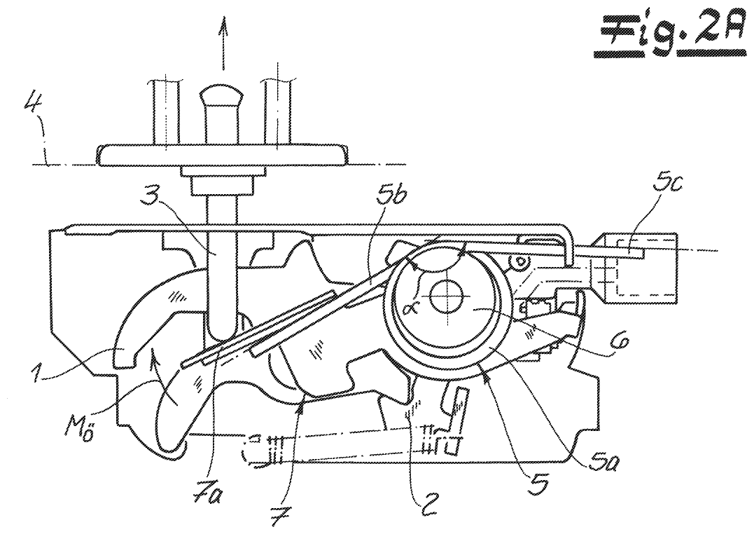

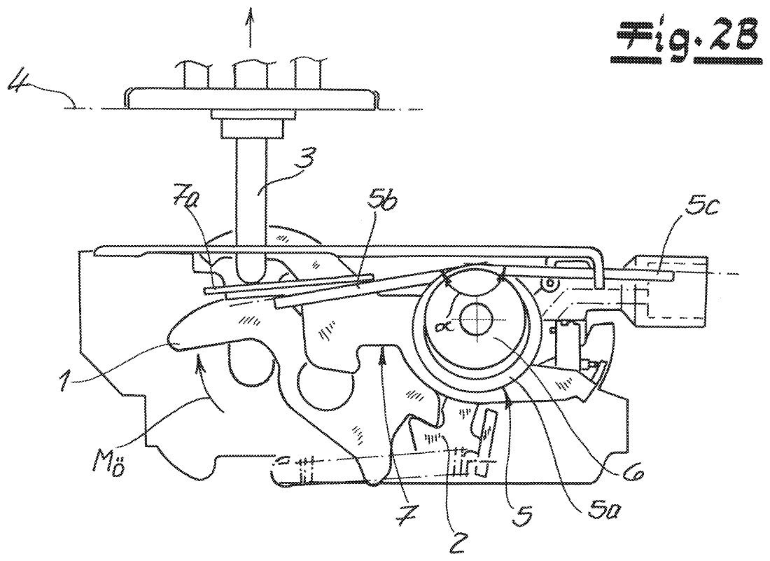

FIGS. 2A, 2B show different positions of the locking mechanism.

The figures show a motor vehicle locking device which is designed according to the exemplary embodiment and preferably as a motor vehicle hood lock. For this purpose, the motor vehicle locking device or the shown motor vehicle hood lock has a locking mechanism 1, 2 consisting substantially of a rotary latch 1 and a pawl 2. In addition, one can see a locking bolt 3 interacting with the locking mechanism 1, 2 which, according to the exemplary embodiment, is connected to a hood or front hood 4 on the underside.

The further basic structure then includes a leg spring 5 for acting on the locking bolt 3 interacting with the locking mechanism 1, 2. According to the exemplary embodiment, the leg spring 5 has a rectangular cross-section and in particular a square cross-section, as the enlarged detail in FIG. 1 clearly shows. In fact, the leg spring 5 in question is made from a spring wire with a rectangular cross-section or square cross-section. The material used for the spring wire is steel and in particular spring steel.

Based on the functional positions in FIGS. 2A, 2B, it can be seen that with the help of the leg spring 5, an opening torque Mo, indicated here by an arrow, is exerted by the leg spring 5 on the locking bolt 3, both in the main ratchet position of the locking mechanism 1, 2 according to FIG. 2A as well as in its associated pre-ratchet position according to the illustration in FIG. 2B.

The special design of the leg spring 5 with the rectangular cross-section or square cross-section according to the invention ensures that the relevant opening torque Mo in the main ratchet position according to FIG. 2A differs in value by a maximum of 30% in comparison to the pre-ratchet position according to the illustration in FIG. 2B. The opening torque Mo provided by the leg spring 5 can provide values between 3 and 6 Nm and preferably 4 and 5 Nm. As a result of this, forces acting on the locking bolt 3 in the opening direction result, which can typically be above 50 N and even 100 N and more.

Structurally, it can be seen that the leg spring 5 with its coil section 5a encloses a bearing pin 6. At this point, a clearance is observed between the winding section 5a in question and the bearing pin 6. In this way, the two legs 5b and 5c extending from the winding section 5a can enclose different angles a between themselves, as can be seen from the illustration in FIGS. 2A and 2B.

According to the exemplary embodiment, the angle α enclosed by the two legs 5b, 5c is an obtuse angle which can assume values between 90° and 180°. In fact, it can be seen that the angle α in the main ratchet position is approximately 150° corresponding to the illustration in FIG. 2A, whereas the pre-ratchet position corresponds to an angle α of approximately 180° corresponding to the illustration in FIG. 2B.

The structural design is not only such that the leg spring 5 with its winding section 5a encloses the respective bearing pin 6. In addition, the leg spring 5 with its loose leg 5b ensures that an additionally provided ejector lever 7 resting on the locking bolt 3 is acted upon. For this purpose, the loose leg 5b of the leg spring 5 in question, which moves together with the ejector lever 7, rests on the underside on a contact edge 7a of the ejector lever 7 according to the exemplary embodiment, against which in turn the locking bolt 3 moves with its bracket. Due to the contacting of the locking bolt 3 with the contact edge 7a of the ejector lever 7, which in turn is acted upon in the opening direction according to the arrow in FIG. 1 by means of the leg spring 5 according to the invention, it is ensured that the locking bolt 3 does not perform any relative movements in the interior of an inlet mouth of the rotary latch 1, and consequently no rattling noises occur.

This applies both to the pre-ratchet position according to FIG. 2B as well as to the main ratchet position corresponding to the illustration in FIG. 2A. This is ensured, among other things, by the fact that the respective forces exerted by the spring 5 in the pre-ratchet position and the main ratchet position on the locking bolt 3 deviate from each other by only a maximum of 30%, as already described in the introduction. As a result, the locking bolt 3 and its bracket in the interior of the inlet mouth of the rotary latch 1 can be expected to hold rattle-free in both locking positions.

### LIST OF REFERENCE SIGNS

1 Rotary latch
2 Pawl
1,2 Locking mechanism
3 Locking bolt
4 Hood or front hood
5 Leg spring
5a Winding section
5b Loose leg
5c Fixed leg
5b, 5c Leg
6 Bearing pin
7 Ejector lever
7a Contact edge
Mo Opening torque
α Angle

1. A motor vehicle locking device, comprising:
a locking mechanism including a rotary latch and a pawl, and
a leg spring for acting on a locking bolt interacting with the locking mechanism, wherein the leg spring has a rectangular cross-section.

2. The motor vehicle locking device according to claim 1, wherein the leg spring has a square cross-section.

3. The motor vehicle locking device according to claim 1, wherein an opening torque exerted by the leg spring deviates between a pre-ratchet position and a main ratchet position of the locking mechanism by a maximum of 30%.

4. The motor vehicle locking device according to claim 1, wherein the leg spring is configured to generates an opening torque between 3 Nm and 6 Nm.

5. The motor vehicle locking device according to claim 1, further comprising a bearing pin, wherein the leg spring has two legs adjoining a winding section and encloses the bearing pin with the winding section.

6. The motor vehicle locking device according to claim 1, further comprising an ejector lever and a housing, wherein the leg spring has a loose leg and a fixed leg, and the loose leg acts on the ejector lever acting on the locking bolt, while the fixed leg is fixed to the housing.

7. The motor vehicle locking device according to claim 5,
wherein the winding section encloses the bearing pin with a clearance so the two legs can form different angles between the two legs.

8. The motor vehicle locking device according to claim 5, wherein two legs adjoining the winding section are joined at an obtuse angle between the legs.

9. The motor vehicle locking device according to claim 8, wherein the obtuse angle has a value between more than 90° and 180°.

10. The motor vehicle locking device according to claim 1, wherein the leg spring is made of steel.

11. The motor vehicle locking device according to claim 1, wherein the leg spring is configured to generate an opening torque between 4 Nm and 5 Nm.

12. The motor vehicle locking device according to claim 8, wherein the obtuse angle has a value between 120° and 180°.

13. The motor vehicle locking device according to claim 7, wherein a first angle of the different angles between the two legs corresponds to a main ratchet position of the locking mechanism and a second angle of the different angles between the two legs corresponds to a pre-ratchet position of the locking mechanism.

14. The motor vehicle locking device according to claim 13, wherein the first angle is less than the second angle.

15. The motor vehicle locking device according to claim 6, wherein the ejector lever and the pawl are mounted on a same axis via a bearing pin that is enclosed by a winding section of the leg spring.
